(19) United States
(12) Patent Application Publication
(10) Pub. No.: US 2005/0080696 A1
(43) Pub. Date: Apr. 14, 2005

(54) Method and system for generating a business case for a server infrastructure

(75) Inventors: Sugato Bagchi, White Plains, NY (US); Robert J. Baseman, Brewster, NY (US); Michael R. Haley, South Salem, NY (US); Al A. Hamid, Columbus, OH (US); Matthew P. Haynos, Ridgefield, CT (US)

Correspondence Address: William A. Kinnaman, Jr.;IBM Corporation - MS P386, 2455 South Road, Poughkeepsie, NY, 12601, US

(73) Assignee: International Business Machines Corporation, Armonk, NY (US)

(21) Appl. No.: 10/685,204

(22) Filed: Oct. 14, 2003

(51) Int. Cl. G06F 17/60

(52) U.S. Cl. 705/35

(57) ABSTRACT

A method and system for generating a business case for one or more alternative server infrastructure scenarios relative to a baseline server infrastructure scenario. A capacity planner determines resource requirements and performance metrics for the server infrastructure scenarios. A total cost of ownership estimator determines from the resource requirements the investment cost for the alternative server infrastructure scenarios and the incremental savings in operating costs for the alternative server infrastructure scenarios relative to the baseline scenario. A business value estimator determines from the performance metrics the incremental business value to a supported business operation of the alternative server infrastructure scenarios relative to the baseline server infrastructure scenario. A business case builder determines whether the total benefit represented by the incremental savings in operating costs and the incremental business value justifies the investment cost for the alternative server infrastructure scenarios. The alternative server infrastructure scenarios may typically include a grid scenario.

### BACKGROUND OF THE INVENTION

1. Field of the Invention

This invention relates to a method and system for generating a business case for a server infrastructure. More particularly, it relates to a method and system for generating a business case for a grid server infrastructure.

2. Description of the Related Art

Information technology (IT) users are always looking for ways to improve their computer infrastructures, especially their server infrastructures, in their quest for efficiencies of operation and competitive advantage. One factor that has accelerated this review of server infrastructure has been the development of “grid” computing, in which computing resources—such as central processing units (CPUs), applications, and storage—are located in a heterogeneous network rather than at fixed locations within a single enterprise. In a grid server infrastructure, the resources in question would be servers, especially their CPU resources but other resources (e.g., applications and storage) as well. One of the signal advantages of a grid infrastructure is that servers that are temporary idle at a particular location on a grid may be accessed from elsewhere, thereby making maximal use of unused computing capacity. While the technical details of grid computing are beyond the scope of this specification, descriptions may be found in such publications as the following, incorporated herein by reference:

1. Ian Foster et al., “The Physiology of the Grid: An Open Grid Services Architecture for Distributed Systems Integration”, Jun. 22, 2002.

2. Steve Tuecke et al., “Grid Service Specification”, Draft 3; Jul. 17, 2002.

In assessing whether to adopt a proposed new infrastructure (server or otherwise), IT users have employed various methodologies to determine whether such new infrastructure makes sense from a business standpoint. One such methodology that has become popular of late is the so-called “return on investment” (ROI) or “return on capital” (ROC) methodology. Using this methodology, one “grades” a proposal (also “scenario” hereinafter) as one would any other investment by assessing its financial “return” (usually stated as an annual percentage rate) on the capital investment cost. For example, an infrastructure scenario that has a capital investment cost $100 million and an annual financial return of $4 million would have an ROI of 4%. The ROI that is assessed in this manner may be compared with those of other infrastructure scenarios (or those achievable by the enterprise elsewhere) to determine whether it is worthwhile. Thus, if the ROI on a first infrastructure scenario is 4% while the return on a second is 6%, the second scenario would be chosen as being the superior investment choice. On the other hand, if the enterprise could achieve a greater return doing something else, then the enterprise would be better off not selecting either scenario. Thus, if the enterprise could obtain an ROI of 10% by investing in the stock market, then it should do that instead.

While there are various tools available for evaluating proposals using ROI criteria, they are not readily adaptable for use in evaluating alternative server infrastructure scenarios since they do not capture all the financial advantage that may accrue to an enterprise from adopting a given scenario. Another drawback of these available tools is that they do not assess the technical feasibility of the scenario before estimating its ROI. This could lead to the development and financial assessment of unrealistic scenarios.

### SUMMARY OF THE INVENTION

In general, the present invention contemplates a method and system for generating a business case for an alternative server infrastructure scenario relative to a baseline server infrastructure scenario. In accordance with the invention, the investment cost for the alternative server scenario is determined, together with the incremental savings in operating costs for the alternative scenario relative to the baseline scenario and the incremental business value to a supported business operation of the alternative scenario relative to said baseline scenario. It is then determined whether the total benefit represented by the incremental savings in operating costs and the incremental business value justifies the investment cost for the alternative server scenario.

In a preferred embodiment of the present invention, a grid value tool comprises four components: a grid capacity planner, a total cost of ownership (TCO) estimator, a business value estimator, and a business case builder. The grid capacity planner determines the resource requirements for various server infrastructure scenarios (typically, at least one “non-grid” scenario and several grid scenarios), together with performance metrics (throughput, response time) for each such scenario.

The TCO estimator determines the total cost of ownership (TCO) for a baseline scenario and various alternative scenarios, using the resource requirements determined by the grid capacity planner. Each TCO has a first component (“asset costs”) representing a one-time investment cost and a second component representing periodic operating costs. The TCO for each alternative scenario is compared with the TCO for the baseline scenario to determine the incremental TCO for that particular scenario, again in terms of both one-time investment cost and periodic operating costs. Typically, the operating costs component of the incremental TCO will be negative, representing a net savings.

The business value estimator estimates the incremental business value to the supported business operation of the various alternative scenarios relative to a base scenario, using the performance metrics determined by the grid capacity planner. This business value is determined for the same reporting period as the operating costs component of the TCO and may represent an increase in revenue, a decrease in fixed or variable costs, or both.

Finally, the business case builder takes the outputs of the TCO estimator and the business value estimator for each alternative scenario and determines the return on capital (ROC), both before and after taxes. For these calculations, the “return” is the savings in the operating costs component of the TCO, together with the incremental business value, while the “capital” is the asset costs component of the incremental TCO. This calculated ROC is compared with the weighted average cost of capital (WACC) to determine whether a particular alternative scenario is financially viable.

### BRIEF DESCRIPTION OF THE DRAWINGS

FIG. 1 shows the basic components of a preferred embodiment of the present invention.

FIG. 2 shows a Grid Value Explorer tree viewer.

FIG. 3 shows an icon for an input page.

FIG. 4 shows an icon for an output page containing tabular data.

FIG. 5 shows an icon for an output page containing charts.

FIG. 6 shows an icon for a folder containing input or output pages.

FIG. 7 shows a menu for initiating calculations.

FIG. 8 shows a Grid Value Model start page.

FIG. 9 shows a model of grid application resource requirements.

FIG. 10 shows the output of the grid capacity planner.

FIG. 11 shows the Server Infrastructure Scenarios page.

FIG. 12 shows a TCO Analysis toolbar.

FIG. 13 shows the Default TCO Rates page.

FIG. 14 shows the Grid Deployment Costs page.

FIG. 15 shows a platform TCO input page.

FIG. 16 shows a framework for modeling business value estimation.

FIG. 17 shows a business value estimation summary page.

FIG. 18 shows a Business Values toolbar.

FIG. 19 shows a business value scenario worksheet.

FIG. 20 shows a business value model for chip verification simulations.

FIG. 21 shows a Business Case Scenarios page.

FIG. 22 shows a Business Case toolbar.

### DESCRIPTION OF THE PREFERRED EMBODIMENTS

Introduction

The present invention helps its users to quantify an estimate of the financial value a business would realize by using a grid computing infrastructure. Proponents of grid computing have pointed out multiple sources of value offered by such an infrastructure, such as: (1) maximizing utilization of existing resources; (2) simplifying the operating environment; (3) improve availability and productivity; (4) enabling collaboration and virtual organizations; (5) enhancing and promoting flexibility

However, businesses need to be able to translate these benefits into quantitative estimates of business and financial value before they can make an investment decision. They are looking for a financial assessment of: (1) the impact of improving resource utilization and simplifying the operating environment on the total cost of ownership (TCO) of the firm's IT infrastructure; and (2) the impact of the potential improvements in the availability, productivity, collaboration and flexibility on the business value received by the firm, either in the form of revenue gain or cost savings in its business operations.

Given the emerging nature of this technology, this quantification cannot be made from historical benchmarks of accrued value which are absent at this point. Instead, businesses need to analyze the value by considering their specific business and IT environment and predicting the impact grid computing will have on them. Another aspect of grid computing technology is that the benefits are closely tied to the types of applications that can utilize the distinctive features of the grid infrastructure.

The present invention addresses these issues by providing an analytical grid value model that predicts the performance of applications running on a grid infrastructure and the utilization of the grid resources and translates these computational measures into financial metrics.

Grid Valuation Usage and Assumptions

The present invention can be used in various phases of a grid initiative. It can be used to make a business case for the investment during the sell phase, using information about the application and the grid infrastructure being proposed to the client.

The tool may also be used during the solution design phase. Here, specific grid design decisions, such as the number and type of servers on the grid and the job scheduling rules and policies can be evaluated on the basis of their impact on the financial value.

Once the grid is deployed, the tool could be part of the monitoring and management process, where the directly measurable IT-level metrics can be translated into financial terms. This helps the management to determine whether the initiative has succeeded in achieving its financial objectives. In case of a shortfall at the financial level, the tool can be used to identify the IT-level metrics responsible for it.

In all of these usage cases, the tool is subject to the following assumptions and limitations:
1. The valuation is being done for a set of applications that will be run on the compute grid. Details about the applications, such as their demand profile, performance on existing hardware (or in case of new applications, the estimated performance on a specific hardware), demand for non-CPU resources, and maximum overall response times are known.

2. The grid infrastructure is assumed to be internal to the company. No usage-based pricing has been incorporated into the model, except to allocate the total cost of ownership of the grid infrastructure on the basis of CPU utilization.

3. The impact of grid on specific ownership costs, such as number of administration and maintenance personnel, is estimated outside of the tool and entered into it along with other ownership costs. That is, the tool does not provide any rules of thumb on the costs.

4. The user may optionally wish to estimate the financial value-add from improved application performance such as faster response or higher throughput. The models for doing so are provided by the user as they are expected to be highly application- and industry-specific. (Over time, a repository of such value-add models could be developed that could be applied to a specific customer situation.)

Overview of Preferred Embodiment

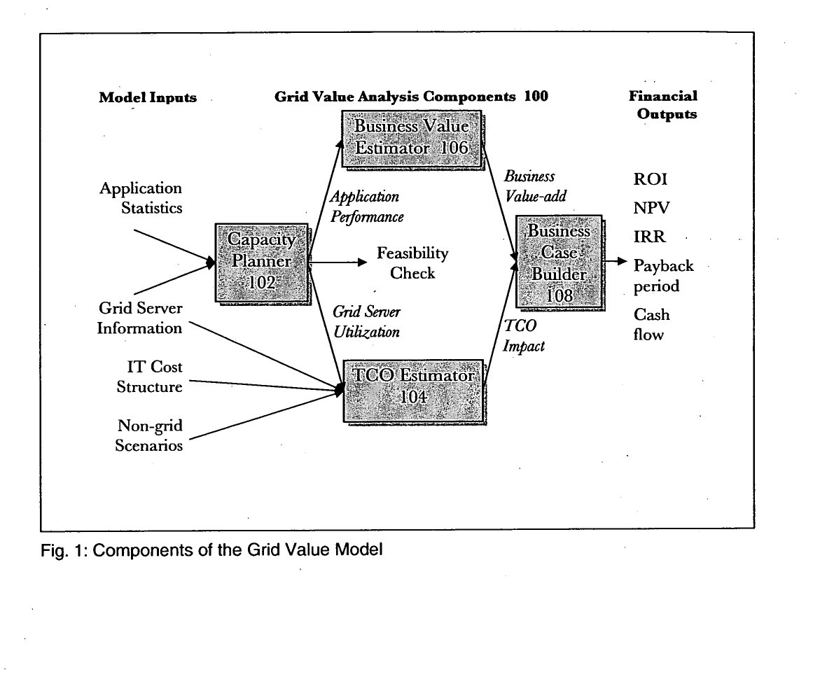

Referring to FIG. 1, a preferred embodiment of the present invention comprises a grid value tool 100 containing four components: a grid capacity planner 102, a TCO estimator 104, a business value estimator 106, and a business case builder 108. Grid value tool 100 comprises a software program that, as described elsewhere, runs in conjunction with a spreadsheet program such as Microsoft™ Excel™. (“Microsoft” and “Excel” are trademarks of Microsoft Corporation.) While the particular hardware/software platform forms no part of the present invention, the grid value tool 100 and the spreadsheet program may run under a Microsoft Windows™ operating system on a general-purpose computer such as an Intel™ Pentium™ or compatible machine. (“Windows” is a trademark of Microsoft Corporation; “Intel” and “Pentium” are trademarks of Intel Corporation.) Since the spreadsheet program, operating system and hardware machine function are well known in the art and function in a conventional manner, they are not shown.

The first step of the analysis estimates the IT-level impact of running an application on the grid infrastructure. This is done in a grid capacity planning step, in which grid capacity planner 102 uses details about the application and the grid infrastructure to estimate (a) the improvement in application performance and (b) the utilization of the grid infrastructure by the application.

Next, in a TCO analysis step, TCO estimator 104 compares the cost of ownership of the grid infrastructure to other alternate server infrastructure scenarios to arrive at an estimation of the present and future infrastructure cost savings (if any) due to grid.

In addition to cost savings, it might also be possible to quantify the business value-add due to the improved application performance. This is performed by business value estimator 106 in a business value estimation step.

Finally, in the business base development step, a business case builder 108 combines the outputs of the TCO estimator 104 and the business value estimator 106 into a number of financial measures typically used to judge the viability of a project.

Using the Grid Value Tool

The grid value tool 100 is designed to work with the Microsoft Excel spreadsheet program, although the invention is certainly not limited to this program and other spreadsheet programs (such as LotuST™ 1-2-3) could be used as well. (“Lotus” is a trademark of IBM Corporation.) The user has the tool to develop or modify a valuation model. The inputs and outputs of a model are stored as an Excel workbook. If this workbook is sent to someone who does not have the tool, he or she can still view the inputs and outputs of the model but will not have the ability to perform the valuation analysis.

To create a new valuation model, the user makes sure that the grid value tool 100 is installed on the computer. From the Windows Start button, the user runs Start>Programs>IBM Grid Value Tool>New Grid Value Model. Alternatively, the user launches Excel, selects the New . . . command from Excel's File menu, and chooses the IBM Grid Value Model template. This template, which is installed with the grid value tool 100, contains the appropriate input and output worksheets required for the analysis. A new workbook based on the selected template will be created.

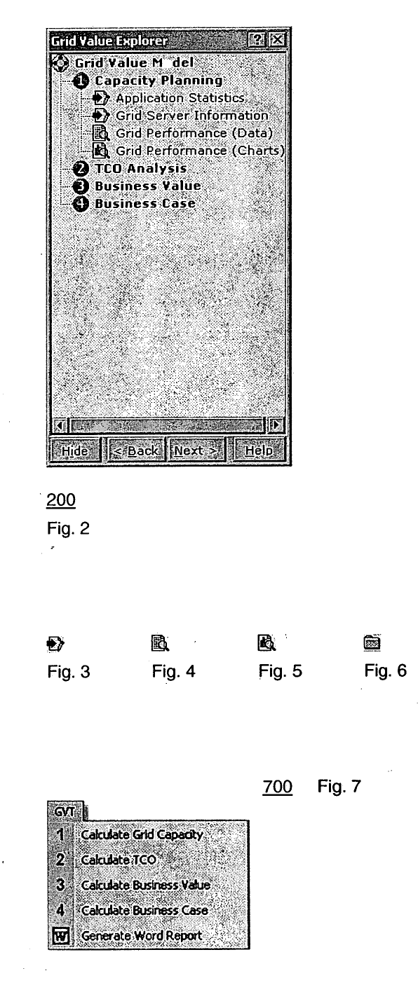

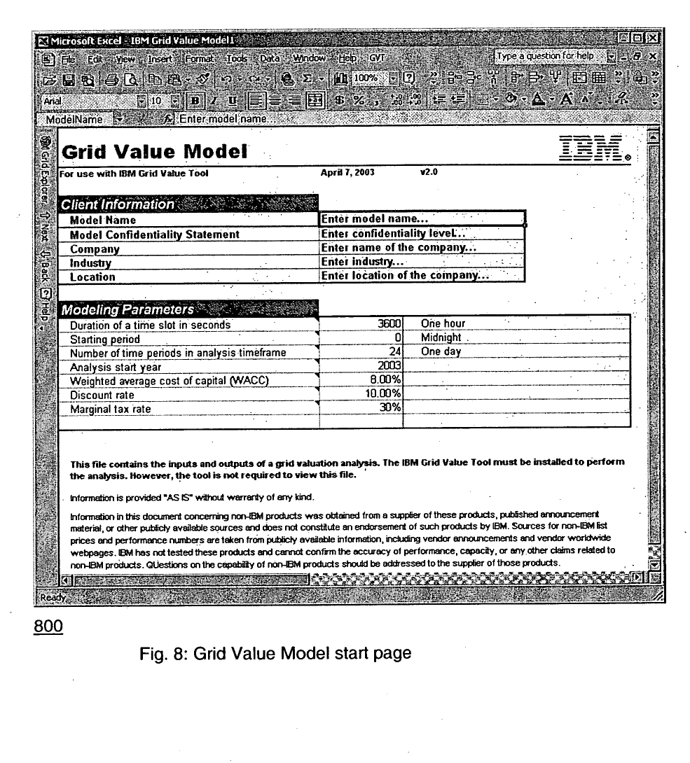

The user clicks on Grid Value Explorer button shown in FIG. 8 to bring up a “tree viewer” 200 shown in FIG. 2. This can be used to navigate to the other pages in the workbook. The start page is the “root” of the navigation tree.

The Grid Value Explorer viewer 200 shows the four key steps in grid valuation, corresponding to the four components of the value model: (1) grid capacity planning, (2) TCO analysis, (3) business value estimation, and (4) business case development. Under each step, there are input and output pages. Input pages are denoted by the icon shown in FIG. 3. Output pages are denoted by the icon shown in FIG. 4 if they contain tabular data and by the icon shown in FIG. 5 if they contain charts. The other type of icon in the navigator is a folder shown in FIG. 6, which contains a collection of either input or output pages.

The Next and Back buttons of viewer 200 take the user through each page in the workbook in the forward or reverse direction respectively. The Hide button is used to remove the Explorer window 200 if it gets in the way of viewing any of the pages. The Grid Value Explorer button on the vertical toolbar shown in FIG. 8 can be used to bring it up again. The Help button will bring up help information about the current page.

The calculations for each of the four steps in the grid valuation analysis can be manually initiated from a grid value tool (GVT) menu 700 shown in FIG. 7. This menu 700 is located to the right of the Help menu on the Excel menu bar. The menu 700 also has a command to generate a Microsoft Word™ report containing the business case analysis and supporting data. (“Word” is a trademark of Microsoft Corporation.)

The Grid Value Model Start Page

FIG. 8 shows the Grid Value Model “start page” 800 that is loaded when the user creates a new model workbook. This page contains the vertical toolbar referenced above and is used for entering some general information about the grid valuation task.

Client Information

The following information is entered about the client on whose behalf this valuation analysis is being done:

Model Name: A short name to identify the model. This name is used on the subsequent pages of the model.

Model Confidentiality Statement: An appropriate statement indicating the confidentiality of the data being entered in this model.

Company: The name of the client company for whom this valuation analysis is being done.

Industry: The client's industry.

Location: The client's geographic location, e.g., country or region.

Modeling Parameters

The following parameters that apply in general across the model are entered:

Duration of a time slot in seconds: This is the duration of a continuous time period for which the grid capacity planning is done. This defines the granularity of the analysis. The time granularity should be large compared to the expected application job response times to ensure that there are not any significant effects due to carryover of jobs from one time slot to another. The default value is 3600 seconds (one hour).

Starting period: The date or time of the first period of the capacity planning analysis. The default value is 0, which corresponds to midnight.

Number of time periods in analysis timeframe: The number of time slots (the duration of which is specified above) for which the grid capacity planning is done. The timeframe of analysis should be large enough to capture the expected peaks and valleys of the application demand profile

Analysis start year: The year when the grid project will be started. The valuation analysis is done over a five year period starting from this year.

Discount rate: The annual rate that should be used to discount future cash flows. This rate should correspond to the interest rate that the company could get for borrowing the money needed to fund the grid project. This rate should be a function of the risk involved with the grid project as well as the general financial health of the company. This rate should be available from the financial personnel in the client organization.

Weighted average cost of capital (WACC): This is the weighted average cost of capital, defined as the weighted average of the costs of the different components of financing, such as equity, debt, and preferred stock used by the firm. This rate should be available from the financial personnel in the client organization.

Marginal tax rate: The tax rate the company would have to pay for an additional unit increment to its earnings. This rate should be available from the financial personnel in the client organization.

The financial rates referenced above may be obtained from existing business case analyses of from line-of-business or corporate financial analysts.

Grid Capacity Planner

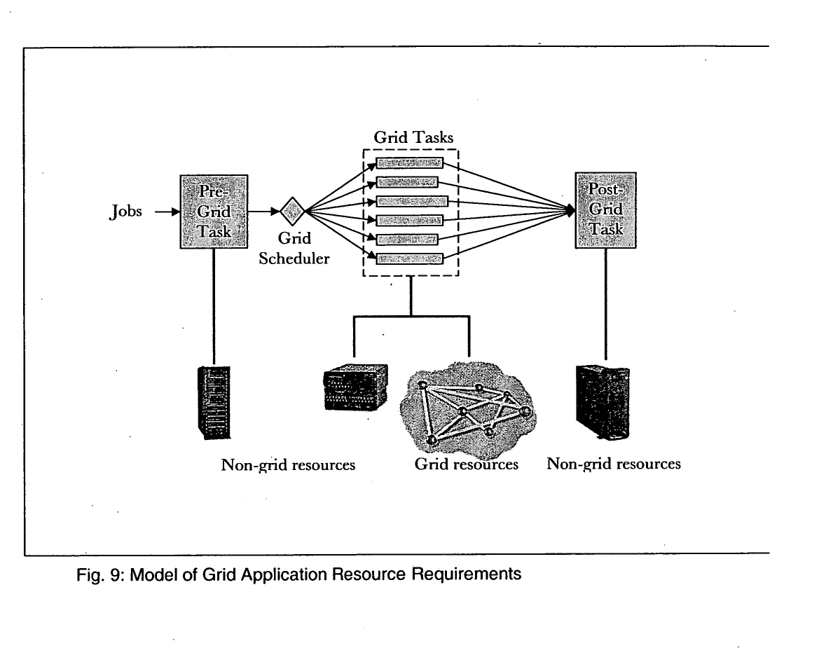

The grid capacity planner 102 (FIG. 1) models the use of the grid resources by the computational jobs of an application and estimates the impact on grid resource utilization and application performance. In addition to the compute resources on the grid, the jobs may also require other resources that are not available on the grid. These could be dedicated servers for accepting the job, scheduling it on the grid, collecting or combining the outputs from the grid and sending them back to the originator of the job, etc. Other resources, such as databases, file systems, and network capacity may also be required by the jobs. These non-grid resources may be divided into two categories, those that are required while a job is executing on a grid server and those that are required before or after the execution on the grid server. These resource requirements are illustrated in FIG. 9.

As shown in FIG. 9, we model the usage of the grid by an application job through a number of tasks that can be run independent of each other. With this, we can model the case where a job is split up into multiple tasks that are scheduled to run in parallel on multiple grid servers. We can also model the situation where the job itself cannot be split up into multiple tasks, but a large number of these jobs have to be performed at the same time. A portion of each job—the part that can utilize the grid resources-can now be routed to a grid server and executed in parallel instead of waiting in a queue for a dedicated resource to process them. (They may still have to wait in queues if the grid or non-grid resources are busy with other jobs.)

Using this model of resource usage, the capacity planner 102 estimates the overall response time of each job. The response time is the actual elapsed time between job submission and job completion including time spent waiting for resources to become available to the job and the job processing time. The response time is calculated on the basis of a specified job arrival rate, the processing time on each resource (grid and non-grid) and the level of utilization of these resources performing other activities. The arrival rates and processing times are assumed to be exponentially distributed random functions.

In addition to the response time, the model also estimates the incremental utilization of the grid resources due to the processing of the jobs. This is done to assess whether there is adequate capacity on the grid to process the arriving jobs, ensuring the feasibility of the infrastructure to handle the demand.

When specified with a maximum response time expected by users (whether informally or due to SLA requirements), the model also computes the maximum throughput of jobs that can be processed by the grid infrastructure. Again, the model can check whether the maximum throughput possible is always greater than the expected throughput.

The analysis of grid resource usage takes into account the resource allocation rules in effect by the grid scheduler. These are the rules that determine the grid server to which an incoming job will be sent for processing. We envision the model to support various types of allocation rules and the comparison of these rules in terms of financial impact. For the present, the model assumes that the resource allocation rule in effect is one where the job is sent to the grid server with the highest idle capacity, defined as follows:
idle capacity=(1−processor utilization)*relative processor power
where “relative processor power” is a measure of how much faster the processor will execute the workload relative to a standard processor.

The grid capacity planning analysis could be done for any desired time frame and granularity. The granularity defines the duration of the time slot for which an analysis is done and the time frame defines the number of such time slots. For example, the granularity could be one hour time slots over a 24 hour time frame, or a one day time slot over a four week time frame. The time granularity should be large compared to the expected job response times to ensure that there are not any significant effects due to carryover of jobs from one time slot to another. The time frame of analysis should be large enough to capture the expected peaks and valleys of the application demand profile.

The grid capacity planning analysis requires the entry of two types of data: application data and grid server data. After entering these inputs, the Calculate Grid Capacity command (1) is run from the GVT menu 700 (FIG. 7) on the Excel menu bar to generate the grid performance table and chart output pages.

Application Statistics

The following data about the application being analyzed is entered on an Application Statistics input page (not shown):

Application Name: The name of the application that is being considered for running on the grid infrastructure.

Type of jobs processed by application: Either interactive or batch. Interactive applications are those where jobs arrive randomly at various times of the day. Batch applications generate jobs at a predefined time.

Average number of jobs for the application that arrive in each period: (This input is only required for interactive jobs as defined above.) The average number of interactive jobs that arrive in each one-hour time slot. This average may be an estimate or computed over a number of days for which data is available.

The number of parallel tasks into which each arriving job can be split: If the application is a parallel one, where each job is split up into a number of parallel tasks to be scheduled on the grid servers, then the number of such parallel tasks is entered. 1 is entered for jobs that will not be split into parallel tasks.

Response time from non-CPU resources needed during parallel task: If a task needs to access non-CPU resources such as databases, file systems, and network bandwidth, while executing on the grid server, the average delay experienced while these non-CPU resources perform their work is entered. A separate average response time is entered for each time slot.

Response time of the sequential (non-grid) portion of each job: If a job requires execution on non-grid servers before and/or after the tasks executed on the grid, the average response time of that portion of the job is entered. A separate average response time is entered for each time slot.

Maximum acceptable job response time (from SLA): The upper limit on the response time that is acceptable by the user. This could be either a service level agreement (SLA) between the IT service provider and the user or an informal expectation from the user. A separate average response time is entered for each time slot.

CPU service time for each parallel task (on reference server and OS): The actual time spent by a server to process each parallel task, not including any wait time. On the same line, the model/type of server, OS and version on which this processing time is measured are noted. This could be the server infrastructure used in the pre-grid (or as-is) scenario.

Reference server type/model: The type and model of the reference server that processes the task in the specified service time.

Reference OS name: The name of the operating system running on the reference server that processes the task in the specified service time.

Reference OS version: The version number of the operating system running on the reference server that processes the task in the specified service time.

Many of the inputs described above require response times. Response time is defined as the total elapsed time from the submission of a job to a resource to the completion of the job. This includes the time spent waiting for a busy resource to become available for the job and the actual job service or processing time. The ‘resource’ may either be a single IT system such as a server or a file system, or a combination of IT systems required to accomplish a task.

These inputs may be obtained from such resources as: (1) existing application, server, and network logs and reports; (2) application/server maintenance personnel; and (3) application designers and architects.

Grid Server Inputs

The following data about the servers on the grid is entered on an Grid Server Information page (not shown). A row is for each server, grouped by platform. The line label corresponds to the column label on the worksheet.

Platform Name: The name of the platform to which the server belongs. A server platform represents a set of servers that are owned and managed by a single IT administrative unit. The servers in a platform are usually homogeneous in terms of server and operating system families so that they may be managed as a group.

Server Name: The server hostname for tracking and identification purposes.

Server Type/Model: The type and model of the server.

OS Name: The name of the operating system running on the server.

OS Version: The version number of the operating system running on the server.

Relative Power: The relative processing power of the server compared to the base server that is specified in the Application worksheet. The relative processing power will depend on the server specifications as well as the nature of the application workload.

Average Utilization of Server by other Applications: The existing average utilization of the grid servers performing tasks other than those belonging to the application being analyzed. The average utilization is expected to vary over the analysis time frame, so a separate value is entered for each analysis time slot.

These inputs may be obtained from such resources as IT management (for information about existing infrastructure that will participate on the grid), grid architects; and third-party grid middleware vendors.

Grid Capacity Planning Outputs

To generate the capacity planning outputs, the Calculate Grid Capacity command (1) is run from the GVT menu 700 (FIG. 7) on the Excel menu bar. This command is automatically run if any changes in the input pages are detected. The outputs of the grid capacity planner 102 are summarized on a Grid Performance (Data) page (not shown). A Grid Performance (Charts) page (not shown) shows the same information as charts.

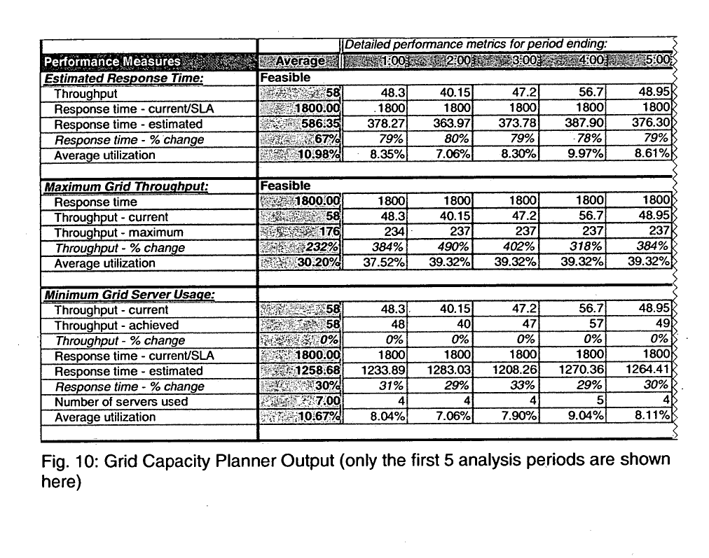

As shown in FIG. 10, three types of analyses are done to predict the performance of the application running on the grid infrastructure. First, the response times for the jobs are estimated for each time slot, based on the throughput expected for the application. If the estimated response time exceeds the specified maximum in any of the time periods, the analysis is labeled as not feasible. The average incremental utilization of the grid servers due to the grid application is calculated for each time slot. This analysis predicts the improvement in application performance from the perspective of processing speed and the resulting impact on the responsiveness of the application to the user. The results of this analysis are presented in a chart format in the Grid Performance (Charts) page.

The outputs of the response time analysis are:

Throughput: This is copied from the input (for reference).

Response time—current/SLA: This is the current or SLA specified response time copied from the input (for reference).

Response time—estimated: This is the average response time for completion of the job. The average is computed for each analysis time slot over the duration of the analysis. This average across all the grid servers, weighted by the number of jobs handled in the time slot.

Response time—% change: This is the percentage change from the current or SLA specified response time provided as input.

Average Utilization: This is the incremental utilization, averaged over all the grid servers, as a result of running the application being analyzed. This calculation is done for each time slot of analysis.

The second analysis estimates the maximum throughput possible for the application. This is the maximum number of jobs that can be processed in each time period subject to the constraint of the maximum response time for each job. If the maximum throughput falls below the expected throughput in any of the time periods, the analysis is labeled as not feasible. The average incremental utilization of the grid servers due to the grid application is calculated for each time slot. This analysis predicts the improvement in application performance from the perspective of processing capacity and the resulting impact on the number of jobs that can be performed in a given time period. The results of this analysis are presented in a chart format in the Grid Performance (Charts) page.

The outputs of the maximum throughput analysis are:

Response time: This is the current or SLA specified response time copied from the input (for reference).

Throughput—current: This is copied from the input (for reference).

Throughput—maximum: This is the maximum number ofjobs that can be processed in each time slot while continuing to maintain the current or SLA specified response time.

Throughput—% change: This is the percentage change from the current throughput.

Average Utilization: This is the incremental utilization, averaged over all the grid servers, as a result of running the application being analyzed. This calculation is done for each time slot of analysis.

The third analysis estimates the minimum number of grid servers that would be required to meet both the expected throughput for the application as well as the maximum response time. This places a lower bound on the number of grid servers necessary to handle the application. The results of this analysis are presented in a chart format in the Grid Performance (Charts) page.

The outputs of the minimum grid server usage analysis are:

Throughput—current: This is copied from the input (for reference).

Throughput—achieved: This is the throughput computed by the analysis. It should be the same as the current throughput.

Throughput—% change: This is the percentage change between the current and achieved throughputs. It should be zero.

Response time—current/SLA: This is the current or SLA specified response time copied from the input (for reference).

Response time—estimated: This is the average response time for completion of the job. The average is computed for each analysis time slot over the duration of the analysis. This average across all the grid servers, weighted by the number of jobs handled in the time slot.

Response time—% change: This is the percentage change from the current or SLA specified response time provided as input.

Number of servers used: The minimum number of servers needed to meet both the job throughput and response time constraints. This analysis is done for each time slot.

Average utilization: This is the incremental utilization, averaged over all (not just the ones used) the grid servers, as a result of running the application being analyzed. This calculation is done for each time slot of analysis.

TCO Estimator

The TCO estimator 104 (FIG. 1) compares the total cost of ownership across multiple server infrastructure scenario alternatives. A server infrastructure scenario is a configuration of servers that support the application under analysis. Typically, there will be an “as-is” scenario for the current server configuration. The TCO of this scenario could be compared with the proposed “grid” scenario. Alternate “non-grid” scenarios, representing competitive proposals could also be developed for comparison with the grid scenario.

Each infrastructure scenario consists of one or more server platforms. A server platform represents a set of servers that are owned and managed by a single IT administrative unit. The servers in a platform are usually homogeneous in terms of server and operating system families so that they may be managed as a group.

The TCO estimator 104 gets the server infrastructure scenarios and the details of the server platforms included in them from the grid capacity planner 102.

The TCO is calculated at the level of server platforms and then aggregated up to the scenarios in which they belong.

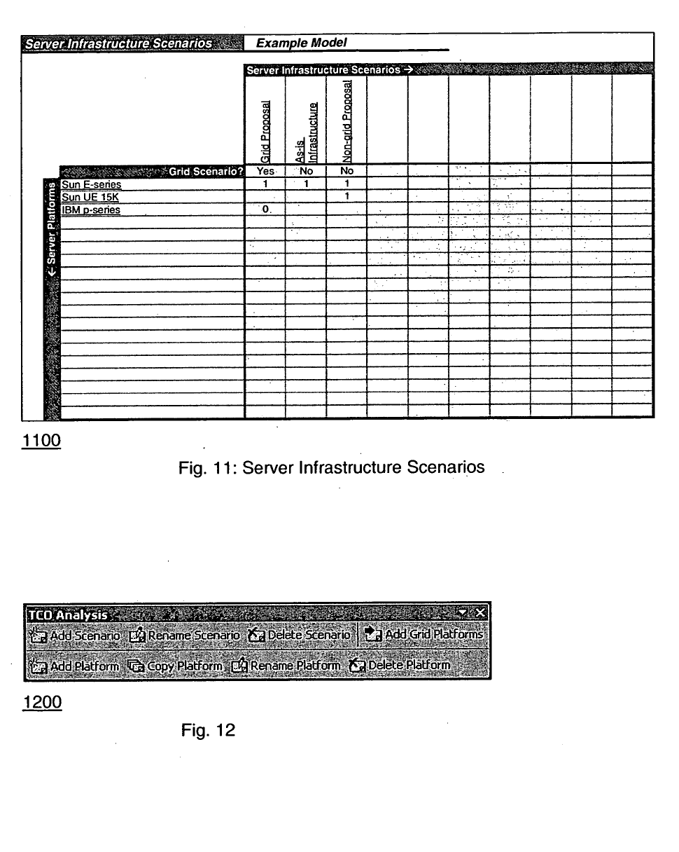

FIG. 11 shows a Server Infrastructure Scenarios input page 1100 containing server infrastructure scenario definitions. To perform the TCO analysis, the cost drivers for each server platform being considered for any of the server scenarios are specified, as well as the cost drivers for deploying the grid. Once these inputs are provided, the Calculate TCO command (2) is run from the GVT menu 700 (FIG. 7) on the Excel menu bar to generate the TCO for each server infrastructure scenario.

Server Infrastructure Scenarios

As noted above, server infrastructure scenarios are defined in the Server Infrastructure Scenarios input page 1100 (FIG. 11). Each scenario includes one or more server platforms. Scenarios and platforms can be created and managed using the buttons on a TCO Analysis toolbar 1200 shown in FIG. 12. This toolbar 1200 is active only on the Server Infrastructure Scenarios input page 1100.

For each server infrastructure scenario added in this page 1100, the user specifies: (a) whether it is a grid scenario (select yes or no); and (b) the server platforms it includes. For each server platform included in the scenario, a number between 0 and 1 is entered in the corresponding cell as shown in FIG. 11. This number signifies the amount of the server platform's TCO that should be included in the aggregate TCO of the scenario. A 0 is entered in the situation where a grid scenario can make use of the idle capacity of a server platform for free. The cell is left blank if a scenario does not make use of a platform.

The server platforms specified in the Grid Server Information input page (see description in the Grid Server Inputs section above during the capacity planning step may be added to the scenario table by clicking on the Add Grid Platforms button on the TCO Analysis toolbar 1200.

Once the server infrastructure scenarios are defined, the cost of each server platform and the grid deployment cost are specified in the following input pages.

Default TCO Rates

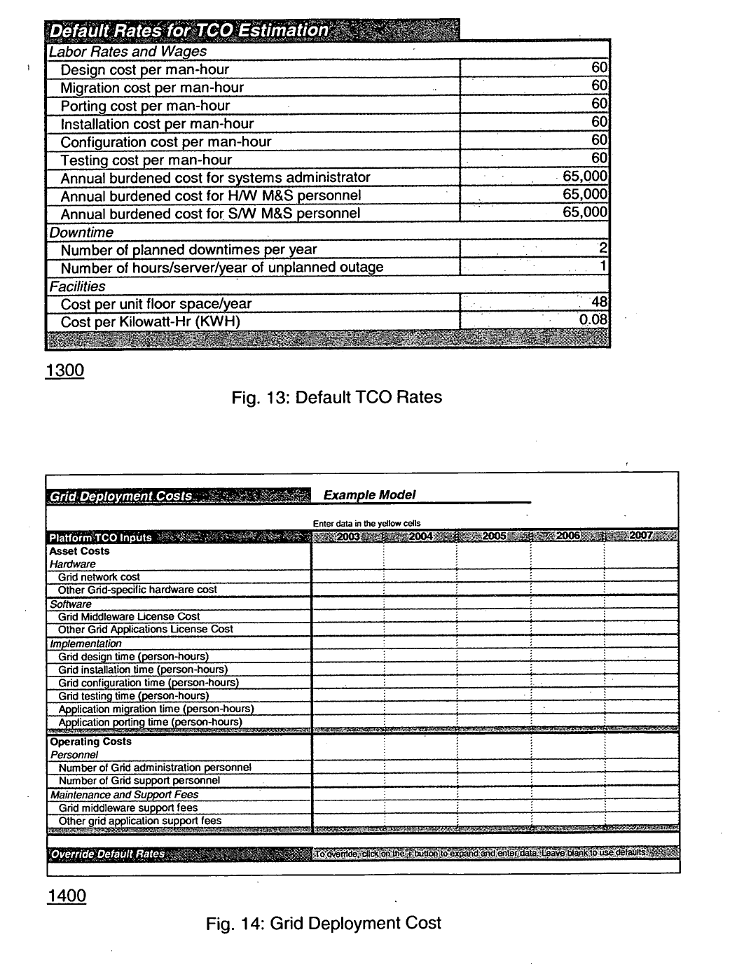

On a Default TCO Rates input page 1300 (FIG. 13), the following rates that will be applied in the calculations of the TCO of server platforms are entered. Any of these default rates may be overridden for a server platform that has a specific rate different from the default.

Labor Rates and Wages

Design cost per man-hour: The hourly rates for performing server infrastructure design.

Migration cost per man-hour: The hourly rates for migrating applications to a server platform.

Porting cost per man-hour: The hourly rates for porting applications to the operating systems and versions used in a server platform.

Installation cost per man-hour: The hourly rates for installation of the server hardware in a server platform.

Configuration cost per man-hour: The hourly rates for configuring the hardware and software of the installed servers in a server platform.

Testing cost per man-hour: The hourly rates for testing the installed and configured servers in a server platform.

Annual burdened cost for systems administrator: The full cost (salary, office space, benefits, etc) of employing a full-time systems administrator for a server platform.

Annual burdened cost for H/W M&S personnel: The full cost (salary, office space, benefits, etc) of employing a full-time maintenance and support person for server platform hardware.

Annual burdened cost for S/W M&S personnel: The full cost (salary, office space, benefits, etc) of employing a full-time maintenance and support person for server platform middleware and applications.

Downtime

Number of planned downtimes per year: The number of times the servers in a server platform are expected to be brought down for scheduled maintenance or upgrades.

Number of hours/server/year of unplanned outage: The number of hours in a year that a server in the server platform will be unavailable due to unexpected crashes and outages.

Facilities

Cost per unit floor space/year: The rental or depreciation cost of a unit area of floor space. Use the same floor space units when specifying the floor area required for a server in a server platform.

Cost per Kilowatt-Hr (KWH): The price paid to the power company for a Kilowatt-hour of electricity needed to power and cool the servers in a server platform.

These inputs may be obtained from existing TCO analysis documents or from IT management.

Grid Deployment Cost

A Grid Deployment Costs input page 1400 (FIG. 14) is used to specify the following line items that comprise the investment required to set up the grid infrastructure over the participating server platforms. Note: to avoid double counting, the TCO of the participating server platforms should not be considered here.

Asset Costs: The following asset costs are entered in the column corresponding to the year in which they are incurred.

Hardware

Grid network cost: Additional investment in network bandwidth required to support the grid infrastructure.

Other Grid-specific hardware cost: Other hardware investments required specifically for the grid infrastructure (e.g., network attached storage, servers for grid services such as scheduling, GIIS, etc).

Software

Grid Middleware License Cost: License cost for the middleware that implements the grid protocols and services.

Other Grid Applications License Cost: License cost of any other applications (e.g., security or encryption) that may be needed especially and exclusively for operating the grid.

Implementation

Grid design time (person-hours): The person-hours needed for designing the grid infrastructure.

Grid installation time (person-hours): The person-hours needed for installing the grid middleware.

Grid configuration time (person-hours): The person-hours needed for configuring the grid middleware.

Grid testing time (person-hours): The person-hours needed for testing that the grid services are working as designed.

Application migration time (person-hours): The person-hours needed for migrating applications that will run on the grid infrastructure.

Application porting time (person-hours): The person-hours needed for porting the applications to run on any of the server platforms.

Operating Costs: The following costs for each year of operation are entered.

Personnel

Number of Grid administration personnel: The number of people needed to perform grid administration duties.

Number of Grid support personnel: The number of people needed to maintain and support the grid middleware running on the servers.

Maintenance and Support Fees

Grid middleware support fees: The annual support fees to be paid to the grid middleware vendors.

Other grid application support fees: The annual support fees to be paid to the vendors of other applications needed to operate the grid infrastructure.

These inputs may be obtained from such resources as grid architects and third-party grid middleware vendors.

Server Platform TCO

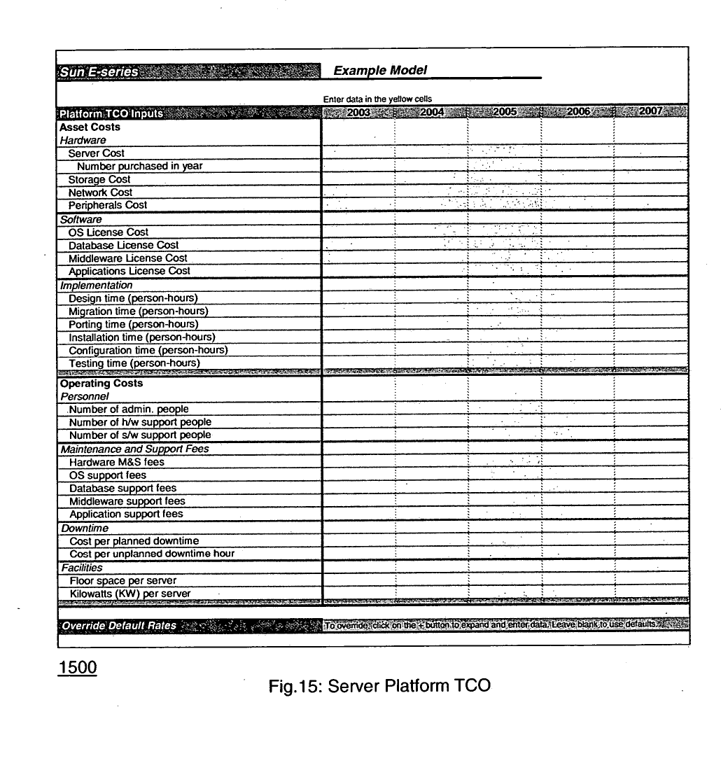

A platform TCO input page 1500 shown in FIG. 15 is created for each server platform specified in the Server Infrastructure Scenarios page 1100 (FIG. 11).

For each server platform enter the following line items that comprise its total cost of ownership. These costs should not account for any grid-specific costs that are already entered in the Grid Deployment Costs page 1400 (FIG. 14).

Asset Costs: The following asset costs in the column corresponding to the year in which they are incurred.

Hardware

Server Cost: The cost of the servers that comprise this platform.

Number purchased in year: The number of servers in this server platform.

Storage Cost: The cost of external storage devices that are exclusively a part of this server platform.

Network Cost: The cost of the networking hardware in this server platform.

Peripherals Cost: The cost of other peripherals, such as monitors, printers, UPS, tape drives, etc. that are exclusively a part of this server platform.

Software

OS License Cost: One time cost to license the operating system used in this server platform. The total cost (cost per license times number of licenses) is entered.

Database License Cost: One time cost to license the number of database seats required in this server platform. The total cost (cost per license times number of licenses) is entered.

Middleware License Cost: One time cost to license the server platform middleware such as messaging, web and application servers, etc. The total cost (cost per license times number of licenses) is entered.

Applications License Cost: One time cost to license the applications that will run on this server platform. The total cost (cost per license times number of licenses) is entered.

Implementation

Design time (person-hours): The person-hours needed for designing the number, type, and configuration of the servers in this server platform.

Migration time (person-hours): The person-hours needed for migration of the applications that will run on this server platform.

Porting time (person-hours): The person-hours needed for porting the applications to the operating systems and versions in this server platform.

Installation time (person-hours): The person-hours needed for installing the hardware, middleware, and applications in this server platform.

Configuration time (person-hours): The person-hours needed for configuring the hardware, middleware, and applications in this server platform.
Testing time (person-hours): The person-hours needed for testing the hardware, middleware, and applications in this server platform.

Operating Costs: The following costs for each year of operation are entered.

Personnel

Number of administrative people: The number of system administrators needed for this server platform.

Number of hardware support people: The number of people needed for maintaining the platform hardware (servers, storage, network, and peripherals).

Number of software support people: The number of people needed for maintaining the operating system, middleware, and applications in this server platform.

Maintenance and Support Fees

Hardware M&S fees: Fees paid to vendors to maintain and support the platform hardware (servers, storage, network, and peripherals).

OS support fees: Fees paid to vendors maintain and support the operating system installed in this server platform.

Database support fees: Fees paid to vendors maintain and support the database management system installed in this server platform.

Middleware support fees: Fees paid to vendors maintain and support the middleware installed in this server platform.

Application support fees: Fees paid to vendors maintain and support the applications installed in this server platform.

Downtime

Cost per planned downtime: Cost incurred at every scheduled downtime for system maintenance or upgrade.

Cost per unplanned downtime hour: Cost, in terms of foregone revenues, penalties, workarounds, and lost work as a result of an hour of unexpected server outage.

Facilities

Floor space per server: The floor space needed (on average) for each server in this server platform. If multiple servers can share the same rack, enter the fraction of floor-space that should be allocated to each server on the rack.

Kilowatts (KW) per server: The power consumed (in Kilowatts) per server. Include the electric power needed to cool the servers if necessary.

These inputs may be obtained from such resources as existing TCO analysis documents and IT management.

TCO Details by Scenario

Once the inputs for the TCO analysis is provided, the user can perform the TCO calculation and generate the outputs. To perform a TCO calculation, the Calculate TCO command (2) is run from the GVT menu 700 (FIG. 7) on the Excel menu bar. This command is automatically run if any changes in the TCO input pages are detected. The TCO of each server infrastructure scenario is calculated and presented as a separate output page with the same name as the scenario. The output pages of all the scenarios are organized under the TCO Details by Scenario folder in the Grid Value Explorer viewer 200 (FIG. 2).

The TCO for the scenario breaks down the total cost of ownership into the following categories:

Asset Costs: These are the capital expenses associated with the server infrastructure comprising of the following categories: (1) hardware assets; (2) software assets; and (3) implementation.

Operating Costs: These are the ongoing expenses to operate the infrastructure, comprising of the following categories: (1) system administration; (2) maintenance and support; (3) downtime; and (4) facilities.

The costs for each year of analysis is presented along with the net present value (NPV) of the multi-year costs, discounted at the rate specified for the model in the Grid Value Model input page 800 (FIG. 8).

TCO Summary

TCO Summary (Data) and TCO Summary (Chart) output pages (not shown) summarize the net present value (NPV) across all server infrastructure scenarios in the form of a table and bar chart, respectively. In the data page, clicking on the scenario names takes the user to the detailed TCO output page for that scenario, where the yearly TCO can be viewed.

The TCO for the scenarios are broken down into the following categories:

Asset Costs: These are the capital expenses associated with the server infrastructure comprising of the following categories: (1) hardware assets; (2) software assets; and (3) implementation.

Operating Costs: These are the ongoing expenses to operate the infrastructure, comprising of the following categories: (1) system administration; maintenance and support; (3) downtime; and (4) facilities.

TCO Savings

TCO Savings (Data) and TCO Savings (Chart) output pages (not shown) compare the TCO of each server infrastructure scenario against a baseline scenario and present the results in the form of a table and bar chart, respectively. The baseline scenario is selected in the TCO Savings (Data) page from among the specified server infrastructure scenarios. Each column of the comparison shows the net present value (NPV) of the estimated cost savings if the baseline scenario is adopted instead of the scenario specified in the column.

The TCO savings are broken down into the following categories:

Asset Costs: These are the capital expenses associated with the server infrastructure comprising of the following categories: (1) hardware assets; (2) software assets; and (3) implementation.

Operating Costs: These are the ongoing expenses to operate the infrastructure, comprising of the following categories: (1) system administration; (2) maintenance and support; (3) downtime; and (4) facilities.

Business Value Estimator

The business value estimator 106 (FIG. 1) estimates the financial value that could be added to the business as a result of improvements in the performance of applications running on the grid, as estimated by the grid capacity planner 102. Application performance may be defined in terms of increase in job throughput, decrease in job response time, or both. The application performance improvement is estimated by the grid capacity planner 102 and provided as input to the business value estimator 106. The financial value could be specified in terms of savings in the operational costs of the business process impacted by the application or in terms of additional revenue.

In a manner similar to that of the other components of the tool 100, a business value calculation is initiated by clicking on the Calculate Business Value button (3) on the GVT toolbar 700 (FIG. 7).

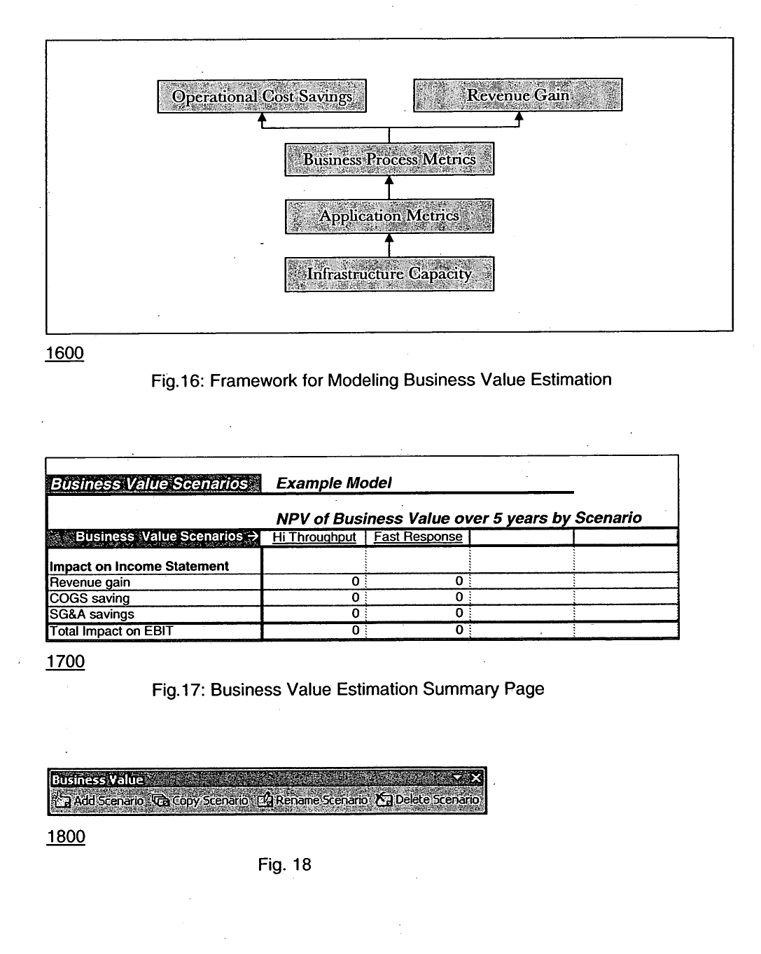

Unlike the other spreadsheets in tool 100, the business value estimator 106 assumes that users have developed their own quantitative models, which are application- and industry-specific. The tool 100 provides a framework 1600, shown in FIG. 16, that makes it possible to integrate the outputs of a business value model into the business case. Using the framework 1600, an application and business process specific model is developed to estimate the financial value of improved application performance. The relationships between application and financial metrics are intermediated through a set of business process metrics and other business factors.

To develop a business value model, the user creates a “business value scenario” where the linkage between application performance and business value is modeled. Very often, the user may wish to develop multiple alternate scenarios of business value to represent different strategies for leveraging the application to realize business value.

FIG. 17 shows a Business Value Scenarios output page 1700 in which the business value scenarios developed for this model are summarized. Each column in the worksheet 1700 represents one business value scenario. For each scenario, the page 1700 summarizes the financial impact in terms of revenue gain, savings in cost of goods sold (COGS), and savings in sales, general, and administrative (SG&A) expenses. The total impact on earnings before interest and taxes (EBIT) is shown on the bottom row.

Business value scenarios can be created and managed using the buttons on a Business Value toolbar 1800 shown in FIG. 18. This toolbar 1800 is active only on the Business Value Scenarios page 1700.

To create a business value scenario, the user clicks on the Add Scenario button on the Business Value toolbar 1700. This prompts for the name of the new scenario and creates a business value scenario worksheet described in the following section.

Very often, the user may want to create a new scenario by altering an existing one. This can be done by first selecting the scenario to be altered in the worksheet 1700 shown on FIG. 17 and then clicking on the Copy Scenario button on the toolbar 1800. Scenarios can be renamed and deleted by first selecting the scenario cell and then clicking the appropriate button from the toolbar 1800. To view any existing scenario, the user clicks on the scenario name, which is hyperlinked to the corresponding business value scenario page.

Creating a Business Value Scenario

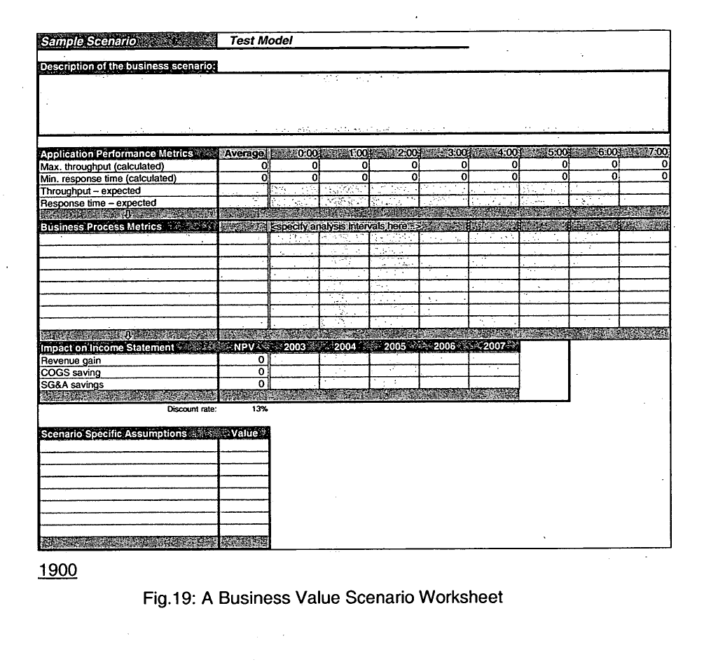

The business value scenario output worksheet 1700 is created from a worksheet 1900 shown in FIG. 19. In this worksheet 1900, the user develops a model that would link application performance metrics to the metrics of the business processes impacted by the application and then link the business process metrics to their impact on the income statement of the business in terms of revenue gain and cost savings.

For each business value scenario, the user develops a model that translates the predicted improvements in application performance, as defined by throughput and response time, into incremental impact on business value, as defined by revenue gain and operating cost savings. The user defines the business process metrics that intermediate between application performance and business value. The following inputs are provided:

Throughput—expected: This is the job throughput expected from the grid infrastructure. This could be specified as an average over the entire analysis duration or for each time slot in the analysis. The specified throughput should not exceed the maximum throughput estimated by the grid capacity planner 102.

Response time—expected: This is the job completion response time expected from the grid infrastructure. This could be specified as an average over the entire analysis duration or for each time slot in the analysis. The specified response time should not be less than the minimum response time estimated by the grid capacity planner 102.

Business Process Metrics: This includes all the business process metrics that are directly or indirectly impacted by the application performance. Next to each metric, formulas are specified to quantify the impact. As with the application performance metrics, this can be done separately for each time slot or on the average value. Other analysis intervals, such as yearly, could also be used. The user can enter additional business process metrics that build a chain or relationships leading to financial value. For each metric, the user specifies a formula that quantifies its relationship to other metrics.

Impact on Income Statement: Here the user specifies formulas to quantify the impact of changes in the business process metrics on the following items in the income statement:

Revenue gain: The additional revenue to the business as a result of improved application performance. Specify formulas to quantify this impact for the number of years in the analysis.

COGS Savings: The savings in the cost of goods sold as a result of improved application performance. Specify formulas to quantify this impact for the number of years in the analysis.

SG&A Savings: The savings in sales, general, and administrative costs as a result of improved application performance. Specify formulas to quantify this impact for the number of years in the analysis.

Scenario-Specific Assumptions: Here the user specifies the name and numerical value of assumptions that are specific to a particular business value scenario. This is done on the worksheet containing the business value scenario.

Depending on the application and industry, development of these models may require skills from line-of-business management of grid application users with knowledge of the business/strategic significance of the application and (based on user interest) business consulting expertise.

Example of a Business Value Scenario

Consider a grid application that performs simulations to test for errors in semiconductor chip designs. Simulations can test only a part of all the possible states that the hardware circuitry could be in. Therefore, increasing the number of simulations is expected to increase the number of errors found in the chip design. Identifying and correcting errors at the design stage results in cost savings in developing the prototype because correcting errors at that stage is more expensive.

The quantitative estimation first starts with the specification of the throughput, which is the number of simulation runs performed on the grid. The actual demand for simulations grew from 50,000 runs to 85,000 runs. This 70% growth is well within and consistent with the estimation from the grid capacity planner 102 that the average number of simulations performed could be increased by 232% due to the capacity available on the grid.

Next, we need to estimate the additional number of bugs that would be found by increasing the number of simulations. This is a non-linear relationship, which we have approximated as follows:
Number of bugs=k*log (number of simulation runs)

The constant k is estimated from the observation that 50,000 simulation runs yield about 20 bugs. Using this formula, we can estimate that the 70% increase in simulation runs will identify one additional bug (21 in all).

What is the cost avoided? If the design was released to the prototype development stage, the cost of fixing the bug would require changing the metallization (30% probability) at the approximate cost of $20,000 or changing the silicon wafer (70% probability) at the cost of $70,000. Assuming 5 chip design phases in the year, we can calculate the avoided cost to be:
5 chip designs*(0.3*$20,000+0.7*$70,000) rework cost*1 bug=$275,000

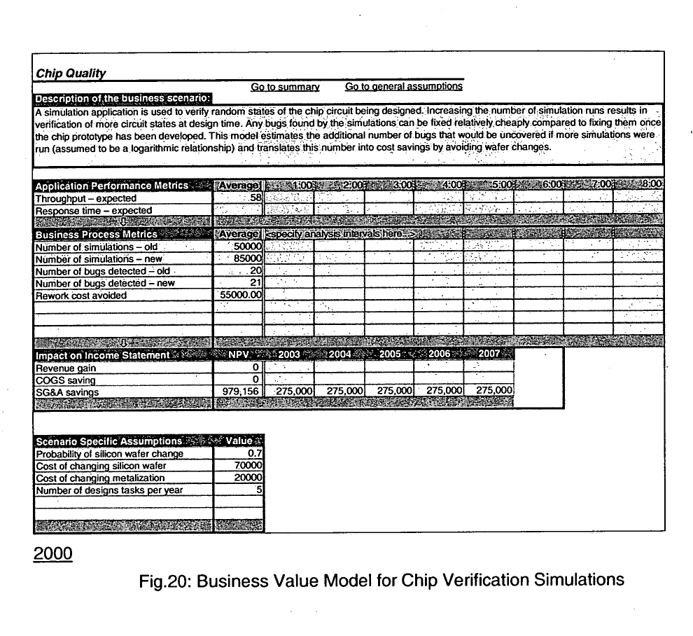

A business value scenario worksheet 2000 containing this model is shown in FIG. 20.

Business Case Builder

The business case builder 108 (FIG. 1) integrates the business value-add as estimated by the business value estimator 106 and IT cost savings and the grid-related investments as estimated by the TCO estimator 104 and develops a set of financial measures that may be used as business justification for the grid investment. The investments in the business case consists of the capital expenses associated with the grid infrastructure scenario from the TCO analysis less any capital expenses avoided from the “as-is” scenario. The benefits in the business case consist of the savings in IT operational costs from the TCO analysis and the financial value-add from the business value estimation.

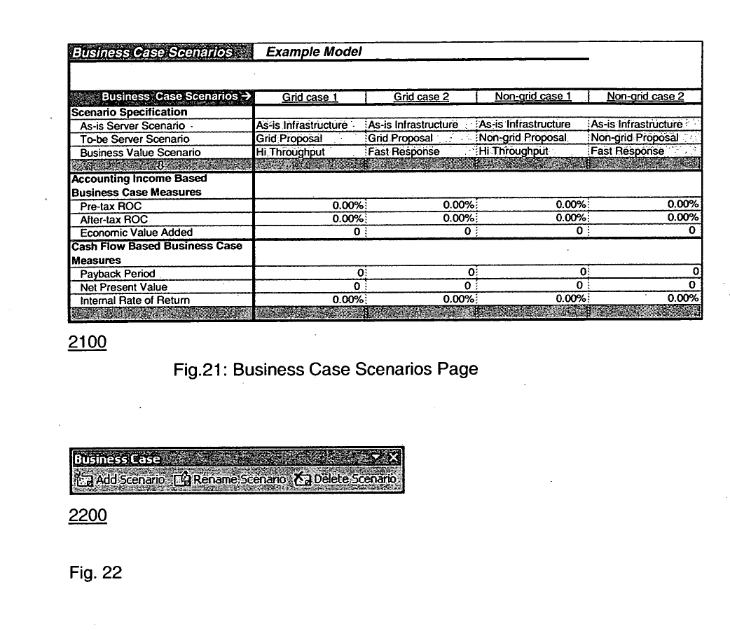

The user may create multiple business case scenarios by using different business value and server infrastructure scenarios as inputs to the business case development. The business case scenarios developed for this model are summarized in a Business Case Scenarios output page 2100 shown in FIG. 21.

Once the business case scenarios are specified, the Calculate Business Case command (4) is run on the GVT menu 700 (FIG. 7) on the Excel menu bar to calculate the financial measures. This command is automatically run if any changes in the input pages are detected.

Business Case Scenarios

Each column of the Business Case Scenarios output page 2100 (FIG. 21) represents one business case scenario. Business case scenarios can be created and managed using the buttons on a Business Case toolbar 2200 shown in FIG. 22. This toolbar 2200 is active only on the Business Case Scenarios page 2100.

For each business case scenario created, the scenarios to be used in the business case are selected. From the server infrastructure scenarios developed in the TCO analysis step, the to-be server scenario is specified. Usually, this is the grid scenario, but one may also want to contrast the business case for the grid scenario with the business case for non-grid proposals) The as-is server scenario is also specified to compare the to-be scenarios against.

Next, a business value scenario is selected that quantifies the financial value-add due to improved performance of the application running on the grid. All of these selections can be made from “pull-down” menus that appear in each cell where a scenario is specified.

Once the business case scenarios are specified, the Calculate Business Case command (4) is run on the GVT menu 700 (FIG. 7) on the Excel menu bar to calculate financial measures that are summarized on the Business Case Scenarios page 2100 for each scenario.

The following financial measures are calculated:

Accounting Income-Based Measures

Pre-tax ROC: The return on capital before taxes. This is calculated as the ratio of the incremental earnings before interest and taxes (EBIT) in the analysis period over the average book value of the invested capital in that period. (We have assumed, perhaps unfairly, that the book value of the investments depreciates to zero at the end of the analysis period. This assumption can be removed in a modified version of the tool, which could handle multiple depreciation periods for different server platforms.) The increment to EBIT is the sum of revenue gain and cost savings (COGS and SG&A) from the business value estimator 106 and the savings in IT operational costs between the to-be and as-is infrastructure scenarios from the TCO estimator 104. The invested capital is the capital expenditures that had to be made for the grid infrastructure, net of any capital expenditures planned for the as-is infrastructure that have been avoided.

After-tax ROC: This is the return on capital after taxes. The calculation is the same as for the pre-tax ROC except that the incremental EBIT is reduced by the amount to be paid as taxes. The after-tax ROC may be compared against a hurdle rate (such as the cost of capital) to decide whether to accept or reject the grid project.

Economic Value Added (EVA): EVA is a measure of the surplus value created by the grid investment. It is calculated by taking difference between the after-tax ROC and the weighted average cost of capital (WACC) and multiplying it by the book value of the capital invested. A positive EVA indicates that the firm is creating value for its shareholders by investing in grid while a negative EVA indicates that it is destroying value.

Cash Flow-Based Measures

Payback Period: This is the period in years by which the initial investment is recovered by the cash flows generated by the grid project. This is calculated from the cumulative free cash flow to the firm (FCFF). This accounts for the business value-add (revenue gain and cost savings) from the business value estimator 106 and the cost savings in IT operational costs net of any cash outflows related to the grid infrastructure. Firms should not look at payback period only to make an investment decision because it does not capture the entire value. Usually, it is used as an additional decision rule or as a tie-breaker between two projects that are similar in the primary financial measure.

Net Present Value (NPV): This is the present value of the benefits of the project, net of investments. This is calculated by discounting the FCFF (see Payback Period above for how FCFF is calculated). The discount rate entered in the worksheet is used to compute the present value of a future cash inflow or outflow. A positive NPV could be used as a decision rule for accepting the grid project. Unlike the ROC measure, the hurdle rate is already factored in the NPV.

Internal Rate of Return (IRR): This is the discount rate for which the NPV as calculated above is zero. The IRR may be compared against a hurdle rate (such as the cost of capital) to decide whether to accept or reject the grid project.

Modifications

Various enhancements can be made to the tool described above. Some are ease-of-use enhancements to the tool, such as country-specific costs sheets, the ability to customize the number of years in the analysis, handling multiple depreciation periods for different server platforms, and developing and linking to a database of relative server performance. Other possible enhancements include such extensions to the model as developing a detailed model of grid enablement costs; modeling grid resource allocation rules and policies; a valuation model for data grids; and modeling the pricing of grid resource usage. Finally, based on initial experience with this tool, we plan to develop a simple tool that performs a high-level estimation of the potential value of grid to a firm based on its existing IT capacity and usage.

While a particular embodiment has been shown and described, various modifications will be apparent to those skilled in the art.

1. A method for generating a business case for an alternative server infrastructure scenario relative to a baseline server infrastructure scenario, comprising the steps of:
determining an investment cost for said alternative server infrastructure scenario;
determining an incremental savings in operating costs for said alternative server infrastructure scenario relative to said baseline server infrastructure scenario;
determining an incremental business value to a supported business operation of said alternative server infrastructure scenario relative to said baseline server infrastructure scenario; and
determining whether the total benefit represented by said incremental savings in operating costs and said incremental business value justifies said investment cost for said alternative server infrastructure scenario.

2. The method of claim 1, further comprising the step of:
determining resource requirements for said server infrastructure scenarios, said investment cost and said incremental savings in operating costs being determined from said resource requirements.

3. The method of claim 1, further comprising the step of:
determining performance metrics for said server infrastructure scenarios, said incremental business value being determined from said performance metrics.

4. The method of claim 1 in which said steps are performed for a plurality of alternative server infrastructure scenarios.

5. The method of claim 1 in which said alternative server infrastructure scenario is a grid-based scenario.

6. The method of claim 1 in which said investment cost is an incremental investment cost of said alternative server infrastructure scenario relative to said baseline server infrastructure scenario.

7. The method of claim 1 in which said step of determining whether said total benefit justifies said investment cost comprises the step of calculating a rate of return of said total benefit on said investment cost.

8. A system for generating a business case for an alternative server infrastructure scenario relative to a baseline server infrastructure scenario, comprising:
a total cost of ownership (TCO) estimator for determining an investment cost for said alternative server infrastructure scenario and for determining an incremental savings in operating costs for said alternative server infrastructure scenario relative to said baseline server infrastructure scenario;
a business value estimator for determining an incremental business value to a supported business operation of said alternative server infrastructure scenario relative to said baseline server infrastructure scenario; and
a business case builder for determining whether the total benefit represented by said incremental savings in operating costs and said incremental business value justifies said investment cost for said alternative server infrastructure scenario.

9. The system of claim 8, further comprising:
a capacity planner for determining resource requirements for said server infrastructure scenarios, said investment cost and said incremental savings in operating costs being determined from said resource requirements.

10. The system of claim 9 in which said capacity planner determines performance metrics for said server infrastructure scenarios, said incremental business value being determined from said performance metrics.

11. The system of claim 8, further comprising:
a capacity planner for determining performance metrics for said server infrastructure scenarios, said incremental business value being determined from said resource requirements.

12. The system of claim 8 in which said business case builder calculates a rate of return of said total benefit on said investment cost.

13. A program storage device readable by a machine, tangibly embodying a program of instructions executable by the machine to perform method steps for generating a business case for an alternative server infrastructure scenario relative to a baseline server infrastructure scenario, said method steps comprising:
determining an investment cost for said alternative server infrastructure scenario;
determining an incremental savings in operating costs for said alternative server infrastructure scenario relative to said baseline server infrastructure scenario;
determining an incremental business value to a supported business operation of said alternative server infrastructure scenario relative to said baseline server infrastructure scenario; and
determining whether the total benefit represented by said incremental savings in operating costs and said incremental business value justifies said investment cost for said alternative server infrastructure scenario.

14. The program storage device of claim 13, said method steps further comprising:
determining resource requirements for said server infrastructure scenarios, said investment cost and said incremental savings in operating costs being determined from said resource requirements.

15. The program storage device of claim 13, said method steps further comprising:
determining performance metrics for said server infrastructure scenarios, said incremental business value being determined from said performance metrics.

16. The program storage device of claim 13 in which said steps are performed for a plurality of alternative server infrastructure scenarios.

17. The program storage device of claim 13 in which said alternative server infrastructure scenario is a grid-based scenario.

18. The program storage device of claim 13 in which said investment cost is an incremental investment cost of said alternative server infrastructure scenario relative to said baseline server infrastructure scenario.

19. The program storage device of claim 13 in which said step of determining whether said total benefit justifies said investment cost comprises the step of calculating a rate of return of said total benefit on said investment cost.
